(19) United States
(12) Patent Application Publication
(10) Pub. No.: US 2021/0158031 A1
(43) Pub. Date: May 27, 2021

(54) Gesture Recognition Method, and Electronic Device and Storage Medium

(71) Applicant: Beijing Sensetime Technology Development Co., Ltd., Beijing (CN)

(72) Inventors: Tianyuan Du, Beijing (CN); Chen Qian, Beijing (CN)

(73) Assignee: Beijing Sensetime Technology Development Co., Ltd., Beijing (CN)

(21) Appl. No.: 17/166,238

(22) Filed: Feb. 3, 2021

Related U.S. Application Data
(63) Continuation of application No. PCT/CN2019/092559, filed on Jun. 24, 2019.

(30) Foreign Application Priority Data
Aug. 17, 2018 (CN) 201810942882.1

(51) Int. Cl. G06K 9/00; G06N 3/04; G06N 3/08; G06K 9/62

(52) U.S. Cl. CPC G06K 9/00355; G06N 3/0454; G06K 9/00375; G06K 9/6259; G06N 3/084

(57) ABSTRACT

The present disclosure relates to a gesture recognition method, a gesture processing method, and apparatuses. The gesture recognition method includes: detecting the states of fingers included in a hand in an image; determining a state vector of the hand according to the states of the fingers; and determining the gesture of the hand according to the state vector of the hand. In embodiments of the present disclosure, the state vector is determined according to the states of the fingers, and the gesture is determined according to the state vector, thereby achieving high recognition efficiency and strong universality.

### CROSS-REFERENCE TO RELATED APPLICATIONS

The present application is a continuation of and claims priority under 35 U.S.C. 120 to PCT Application. No. PCT/CN2019/092559, filed on Jun. 24, 2019, which claims priority to Chinese Patent Application No. 201810942882.1, filed with the Chinese Patent Office on Aug. 17, 2018 and entitled “GESTURE RECOGNITION METHOD, GESTURE PROCESSING METHOD, AND APPARATUSES”. All the above-referenced priority documents are incorporated herein by reference in their entireties.

### TECHNICAL FIELD

The present disclosure relates to technical field of image processing, and in particular, to a gesture recognition method, a gesture processing method, and apparatuses.

### BACKGROUND

A non-contact human-machine interaction scenario is more and more widely applied in life. A user may conveniently express different human-machine interaction instructions by using different gestures.

### SUMMARY

The present disclosure provides technical solutions for gesture recognition.

According to one aspect of the present disclosure, provided is a gesture recognition method, including: detecting the states of fingers included in a hand in an image; determining a state vector of the hand according to the states of the fingers; and determining the gesture of the hand according to the state vector of the hand.

According to one aspect of the present disclosure, provided is a gesture processing method. The method includes: acquiring an image; recognizing the gesture of a hand included in the image by using the foregoing gesture recognition method; and executing a control operation corresponding to the recognition result of the gesture.

According to one aspect of the present disclosure, provided is a gesture recognition apparatus. The apparatus includes: a state detection module configured to detect the states of fingers included in a hand in an image; a state vector acquisition module configured to determine a state vector of the hand according to the states of the fingers; and a gesture determination module configured to determine the gesture of the hand according to the state vector of the hand.

According to one aspect of the present disclosure, provided is a gesture processing apparatus. The apparatus includes: an image acquisition module configured to acquire an image; a gesture acquisition module configured to recognize the gesture of a hand included in the image by using the foregoing gesture recognition apparatus; and an operation execution module configured to execute a control operation corresponding to the recognition result of the gesture.

According to one aspect of the present disclosure, provided is an electronic device, including: a processor; and a memory configured to store processor-executable instructions, where the processor executes the foregoing gesture recognition method and/or gesture processing method by invoking the executable instructions.

According to one aspect of the present disclosure, provided is a computer-readable storage medium, having computer program instructions stored thereon, where when the computer program instructions are executed by a processor, the foregoing gesture recognition method and/or gesture processing method is implemented.

According to one aspect of the present disclosure, provided is a computer program, including a computer-readable code, where when the computer-readable code runs in an electronic device, a processor in the electronic device executes the foregoing gesture recognition method and/or gesture processing method.

In embodiments of the present disclosure, the states of fingers included in a hand in an image are detected, a state vector of the hand is determined according to the states of the fingers, and the gesture of the hand is determined according to the determined state vector of the hand. In the embodiments of the present disclosure, the state vector is determined according to the states of the fingers, and the gesture is determined according to the state vector, thereby achieving high recognition efficiency and strong universality.

The other features and aspects of the present disclosure can be described more clearly according to the detailed descriptions of the exemplary embodiments in the accompanying drawings.

### BRIEF DESCRIPTION OF THE DRAWINGS

The accompanying drawings included in the specification and constituting a part of the specification illustrate the exemplary embodiments, features, and aspects of the present disclosure together with the specification, and are used for explaining the principles of the present disclosure.

FIG. 1 shows a flowchart of a gesture recognition method according to embodiments of the present disclosure;

FIG. 2 shows a state schematic diagram of fingers in a gesture recognition method according to embodiments of the present disclosure;

FIG. 3 shows a flowchart of a gesture recognition method according to embodiments of the present disclosure;

FIG. 4 shows a flowchart of a gesture recognition method according to embodiments of the present disclosure;

FIG. 5 shows a flowchart of a gesture recognition method according to embodiments of the present disclosure;

FIG. 6 shows a data processing flowchart of a neural network in a gesture recognition method according to embodiments of the present disclosure;

FIG. 7 shows a flowchart of a gesture recognition method according to embodiments of the present disclosure;

FIG. 8 shows a flowchart of a gesture processing method according to embodiments of the present disclosure;

FIG. 9 shows a block diagram of a gesture recognition apparatus according to embodiments of the present disclosure;

FIG. 10 shows a block diagram of gesture processing apparatus according to embodiments of the present disclosure;

FIG. 11 is a block diagram of an electronic device shown according to exemplary embodiments; and

FIG. 12 is a block diagram of an electronic device shown according to exemplary embodiments.

### DETAILED DESCRIPTION

The various exemplary embodiments, features, and aspects of the present disclosure are described below in detail with reference to the accompanying drawings. The same signs in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

In addition, numerous details are given in the following detailed description for the purpose of better explaining the present disclosure. It should be understood by persons skilled in the art that the present disclosure can still be implemented even without some of those details. In some of the examples, methods, means, elements, and circuits that are well known to persons skilled in the art are not described in detail so that the principle of the present disclosure becomes apparent. The following several specific embodiments can be combined with each other, and the same or similar concepts or processes may not be described in some embodiments repeatedly. It may be understood that the following embodiments are only optional implementations of the present disclosure, and should not be understood as substantially limiting the scope of protection of the present disclosure, and on this basis, persons skilled in the art may use other implementations, which all fall within the scope of protection of the present disclosure.

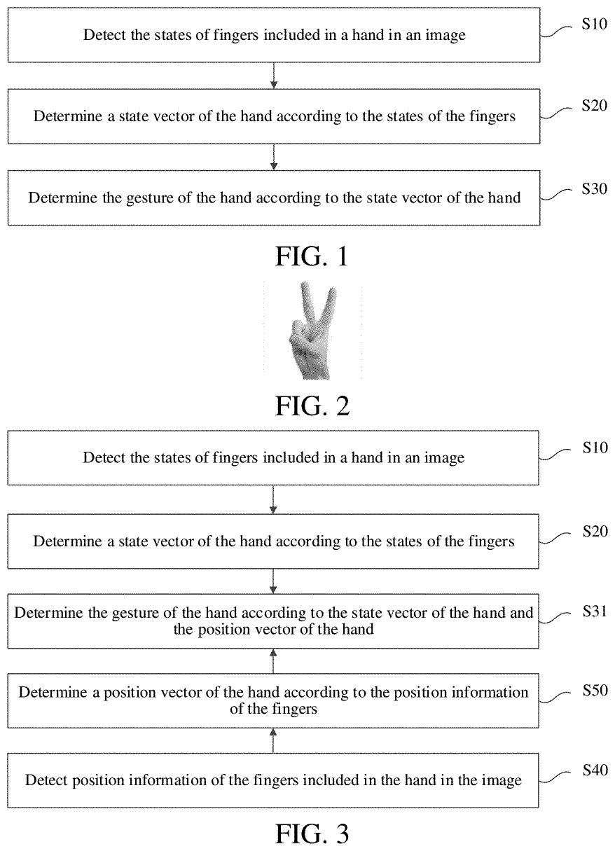

FIG. 1 shows a flowchart of a gesture recognition method according to embodiments of the present disclosure. The gesture recognition method may be executed by an electronic device such as a terminal device or a server, where the terminal device may be a User Equipment (UE), a mobile device, a user terminal, a terminal, a cellular phone, a cordless phone, a Personal Digital Assistant (PDA), a handheld device, a computing device, a vehicle-mounted device, a wearable device, or the like. In some possible implementations, the gesture recognition method may be implemented by a processor by invoking computer-readable instructions stored in a memory.

As shown in FIG. 1, the method includes the following steps.

At step S10, the states of fingers included in a hand in an image are detected.

In one possible implementation, the image may be a static image, or may be a frame image in a video stream. The states of the fingers in the hand may be acquired from the image by using an image recognition method. The states of five fingers in the hand may be acquired, or the state of multiple or single specified finger may be obtained. For example, only the state of the forefinger may be acquired.

In one possible implementation, the states of the fingers represent the states of whether the fingers are outstretched with respect to the base of the palm of the hand and/or the extent of outstretching. When the gesture of the hand is making a fist, the fingers are in a non-outstretched state with respect to the base of the palm. When the fingers are in an outstretched state with respect to the base of the palm, the states of the fingers may also be further divided according to the positions of the fingers with respect to the palm or the degrees of bending of the fingers per se. For example, the states of the fingers may be divided into two states, i.e., a non-outstretched state and an outstretched state, may also be divided into three states, i.e., a non-outstretched state, a half-outstretched state, and an outstretched state, and may further be divided into multiple states such as an outstretched state, a non-outstretched state, a half-outstretched state, and a bent state.

In one possible implementation, the states of the fingers include one or more of the following: an outstretched state, a non-outstretched state, a half-outstretched state, or a bent state. According to the position relationship between the fingers and the palm and the degrees of bending of the fingers per se, in the process from fist making to outstretching of all the five fingers of the hand, the states of the fingers may sequentially be: a non-outstretched state, a half-outstretched state, a bent state, and an outstretched state. Different state levels may further be divided for different states of the fingers according to requirements. The present disclosure does not limit the classification mode, number, and use order of the states of the fingers.

FIG. 2 shows a state schematic diagram of fingers in a gesture recognition method according to embodiments of the present disclosure. In an image shown in FIG. 2, the state of the thumb is in a non-outstretched state, the state of the forefinger is an outstretched state, the state of the middle finger is an outstretched state, the state of the ring finger is in a non-outstretched state, and the state of the little finger is in a non-outstretched state. The states of all the five fingers may be acquired from the image, or the states of specified fingers (such as the forefinger and the middle finger) may be acquired.

At step S20, a state vector of the hand is determined according to the states of the fingers.

In one possible implementation, the determining a state vector of the hand according to the states of the fingers includes: determining state values of the fingers according to the states of the fingers, where the state values of fingers corresponding to different states are different; and determining a state vector of the hand according to the state values of the fingers.

In one possible implementation, corresponding state values may be determined for different states of the fingers, and correspondences between the states of the fingers and the state values are established. The state values of the fingers may be one or any combination of numbers, letters, or symbols. The state values of the fingers may be determined according to the acquired states of the fingers and the established correspondences, and then the state value of the hand is obtained by using the states of the fingers. The state vector of the hand may include various forms such as an array, a list, or a matrix.

In one possible implementation, the state values of the fingers may be combined in a set order of the fingers to obtain the state vector of the hand. For example, the state vector of the hand may be obtained according to the state values of the five fingers. The state values of the five fingers are combined in the order of the thumb, the forefinger, the middle finger, the ring finger, and the little finger to obtain the state vector of the hand. The state values of the fingers may also be combined in other any set order to obtain the state vector of the hand.

For example, in the image as shown in FIG. 2, a state value A may be used for representing a non-outstretched state, and a state value B may be used for representing an outstretched state. As shown in FIG. 2, the state value of the thumb is A, the state value of the forefinger is B, the state value of the middle finger is B, the state value of the ring finger is A, and the state value of the little finger is A. Then the state vector of the hand may be (A, B, B, A, A).

At step S30, the gesture of the hand is determined according to the state vector of the hand.

In one possible implementation, the gesture of the hand may be determined by using the states of the fingers in the hand. Different states of the fingers may be determined according to requirements, the state vector of the hand is determined according to the different states of the fingers, and the gesture of the hand is determined according to the state vector of the hand. The recognition process of the states of the fingers is convenient and reliable, so that the determination process of the gesture is also more convenient and reliable. The correspondence between the state vector of the hand and the gesture may be established, and by adjusting the correspondence between the state vector and the gesture, the gesture may be determined more flexibly according to the state vector, so that the determination process of the gesture is more flexible, and can adapt to different application environments. For example, the state vector 1 of the hand corresponds to a gesture 1, the state vector 2 of the hand corresponds to a gesture 2, and the state vector 3 of the hand corresponds to a gesture 3. The correspondence between the state vector of the hand and the gesture may be determined according to requirements. The state vector of one hand may correspond to one gesture, or the state vectors of multiple hands correspond to one gesture.

In one possible implementation, for example, in the image as shown in FIG. 2, the state vector of the hand is (A, B, B, A, A), in the correspondence between the state vector of the hand and the gesture, the gesture corresponding to the state vector being (A, B, B, A, A) may be “number 2” or “victory”.

In the present embodiment, the states of fingers included in a hand in an image are detected, a state vector of the hand is determined according to the states of the fingers, and the gesture of the hand is determined according to the determined state vector of the hand. In the embodiments of the present disclosure, the state vector is determined according to the state of the fingers, and the gesture is determined according to the state vector, thereby achieving high recognition efficiency and strong universality.

In the present embodiment, the recognition efficiency of recognizing the states of the fingers from the image is high, so that the recognition efficiency of recognizing the gesture is high. Moreover, in the present embodiment, the correspondence between the states of the fingers and the gesture may be arbitrarily adjusted according to requirements, and according to the same image, different gestures defined under different requirements may be recognized, so that the determined gesture has strong universality.

In one possible implementation, the states of the fingers include an outstretched state or a non-outstretched state, and the determining a state vector of the hand according to the states of the fingers includes:

when the state of a finger is an outstretched state, determining that the state value of the finger is a first state value; or

when the state of a finger is in a non-outstretched state, determining that the state value of the finger is a second state value; and

determining a state vector of the hand according to the state of the finger.

In one possible implementation, the first state value and the second state may be represented by using one or any combination of a number, a letter, or a symbol. The first state value and the second state may be two values representing opposite meanings. For example, the first state value may be valid and the second state value may be invalid. The first state value and the second state may also be two numbers with different values. For example, the first state value may be 1 and the second state value may be 0. In the image as shown in FIG. 2, the state value of the thumb is 0, the state value of the forefinger is 1, the state value of the middle finger is 1, the state value of the ring finger is 0, the state value of the little finger is 0, and the state vector of the hand is (0, 1, 1, 0, 0).

In the present embodiment, the first state value and the second state value may be used for determining the state vector of the hand. The states of the fingers of the hand may be simply and intuitively expressed by using the state vector of the hand consisting of two state values.

FIG. 3 shows a flowchart of a gesture recognition method according to embodiments of the present disclosure. As shown in FIG. 3, the method further includes the following steps.

At step S40, position information of the fingers included in the hand in the image is detected.

In one possible implementation, the position information of the fingers may include position information of the fingers in the image. The position information of the fingers may include coordinate position information of pixels of the fingers in the image. The image may also be segmented into a grid, and position information of the grid where the pixels of the fingers are located is determined as the position information of the fingers. The position information of the grid may include serial numbers of the grid.

In one possible implementation, the position information of the fingers may also include position information of the fingers with respect to a target object in the image. For example, the picture in the image is a person playing the piano, the position information of the fingers in the image may include position information of the fingers with respect to a piano keyboard. For example, the distance from a finger 1 to the piano keyboard is 0, the distance from a finger 2 to the piano keyboard is 3 cm, and the like.

In one possible implementation, the position information of the fingers may include one-dimensional or multi-dimensional position information. Relative position relationships between the fingers may be obtained according to the position information of the fingers.

At step S50, a state vector of the hand is determined according to the position information of the fingers.

In one possible implementation, position information of different fingers may be combined in a set order of the fingers to obtain a position vector of the hand. The position vector of the hand may include various forms such as an array, a list, or a matrix.

Step S30 includes the following step.

At step S31, the gesture of the hand is determined according to the state vector of the hand and the position vector of the hand.

In one possible implementation, the states of the fingers in the hand may be obtained according to the state vector of the hand, and a more precise gesture may be determined in combination with the positions of the fingers in the position vector of the hand. For example, in the image as shown in FIG. 2, the state vector of the hand is (0, 1, 1, 0, 0), and the position vector is (L1, L2, L3, L4, L5). If it may be determined that the states of the forefinger and middle fingers are an outstretched state and the other fingers are in a non-outstretched state only according to the state vector of the hand, it may be determined that the gesture of the hand is “number 2” or “victory” according to the state vector of the hand.

If it may be determined that the forefinger and the middle finger are outstretched and spread apart by a certain angle by combining the position vector of the hand with the state vector of the hand, as shown in FIG. 2, the gesture of the hand may be “number 2” or “victory”. If it may be determined that the forefinger and the middle finger are outstretched and held together according to the state vector of the hand and the position vector of the hand (not shown in the drawing), the gesture of the hand may be “number 2” and cannot be “victory”.

The state vector of the hand and the position vector of the hand may be combined according to requirements to obtain a combination vector, and then a correspondence between the combination vector and the gesture is established. Different combination vectors formed by a same state vector and different position vectors may correspond to different gestures or may correspond to a same gesture.

In the present embodiment, the gesture of the hand may be determined according to the state vector and position vector of the hand. A more precise gesture may be obtained by combining the position vector and state vector of the hand.

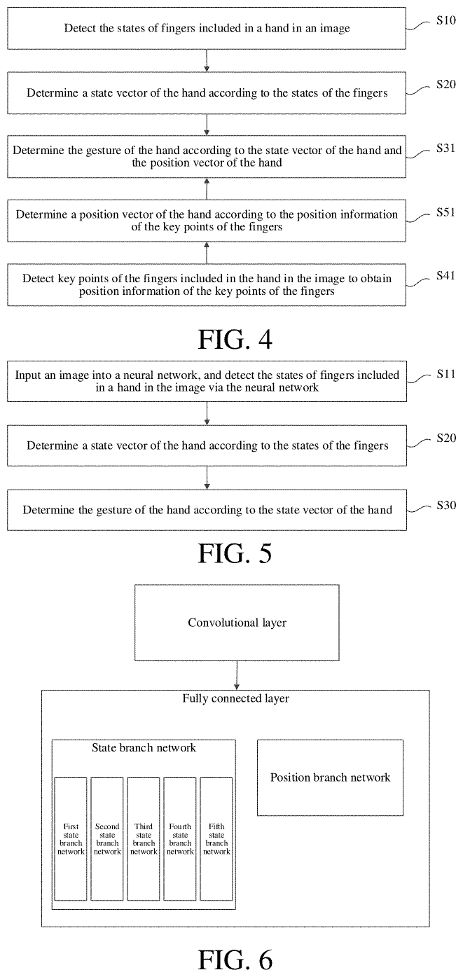

FIG. 4 shows a flowchart of a gesture recognition method according to embodiments of the present disclosure. As shown in FIG. 4, step S40 in the method includes the following step.

At step S41, key points of the fingers included in the hand in the image are detected to obtain position information of the key points of the fingers.

In one possible implementation, the key points include fingertips and/or phalangeal joints, where the phalangeal joints may include metacarpophalangeal joints or interphalangeal joints. The position information of the fingers may be accurately represented by using positions of the fingertips and/or phalangeal joints of the fingers. For example, in the image as shown in FIG. 2, the key points of the fingers are fingertips, it may be determined that the position information of the fingertips of the fingers is: the thumb (X₁, Y₁), the forefinger (X₂, Y₂), the middle finger (X₃, Y₃), the ring finger (X₄, Y₄), and the little finger (X₅, Y₅), where the coordinate points of the fingertips of the thumb, ring finger, and little finger are relatively proximate.

Step S50 includes the following step.

At step S51, a position vector of the hand is determined according to the position information of the key points of the fingers.

In one possible implementation, for example, in the image as shown in FIG. 2, the position vector of the hand may be (X₁, Y₁, X₂, Y₂, X₃, Y₃, X₄, Y₄, X₅, Y₅).

According to the state vector (0, 1, 1, 0, 0) of the hand and the position vector (X₁, Y₁, X₂, Y₂, X₃, Y₃, X₄, Y₄, X₅, Y₅) of the hand, it may be determined that the forefinger and middle finger of the hand are outstretched and fingertips are spaced apart by a certain distance, the remaining three fingers are held together at the position of the palm, and the gesture of the hand is “victory”.

In the present embodiment, the position vector of the hand may be obtained according to the position information of the key points of the fingers of the hand. Thus, the determination process of the position vector of the hand is simpler.

In one possible implementation, step S41 includes: detecting key points of fingers, which are not in a non-outstretched state, included in the hand in the image, to obtain position information of the key points.

In one possible implementation, the gesture may be determined according to the fingers which are not in the non-outstretched state, and therefore, the key points of the fingers which are not in the non-outstretched state may be determined from the image, and the position information of the key points is obtained. The position coordinate of the key point of the finger in a non-outstretched state may be determined as a coordinate value that does not exist in the image. For example, the upper edge of the image may be taken as an X-axis forward direction, the left edge may be taken as a Y-axis forward direction, and an invalid coordinate may be (−1, −1).

In the image as shown in FIG. 2, the upper edge of the image may be taken as an X-axis forward direction, the left edge may be taken as a Y-axis forward direction, the key points of the fingers are fingertips, and according to the state vector (0, 1, 1, 0, 0) of the hand, the position information of the fingertips of the fingers acquired from the image is: the thumb (−1, −1), the forefinger (X₂, Y₂), the middle finger (X₃, Y₃), the ring finger (−1, −1), and the little finger (−1, −1). The position vector of the hand may be (−1, −1, X₂, Y₂, X₃, Y₃, −1, −1, −1, −1). The position coordinates of the key points of the fingers in the non-outstretched state may also be zeroized.

According to the state vector (0, 1, 1, 0, 0) of the hand and the position vector (−1, −1, X₂, Y₂, X₃, Y₃, −1, −1, −1, −1) of the hand, it may be determined that the forefinger and middle finger of the hand are outstretched and fingertips are spaced apart by a certain distance, the remaining three fingers are held together at the position of the palm, and the gesture of the hand is “victory”.

In the present embodiment, the position vector of the hand may be obtained according to the position information of the key points of the fingers which are not in the non-outstretched state. Thus, the determination process of the position vector of the hand is more efficient.

FIG. 5 shows a flowchart of a gesture recognition method according to embodiments of the present disclosure. As shown in FIG. 5, step S10 in the method includes the following step.

At step S11, the image is input into a neural network, and the states of the fingers included in the hand in the image are detected via the neural network.

In one possible implementation, the neural network is a mathematical model or computational model simulating the structure and function of a biological neural network. The neural network may include an input layer, an intermediate layer, and an output layer. The input layer is responsible for receiving input data from the outside and transferring the input data to the intermediate layer. The intermediate layer is responsible for information exchange, and according to the requirements for information change for capability, the intermediate layer may be designed as a single hidden layer or multiple hidden layers. The intermediate layer transfers the output result to the output layer for further processing to obtain the output result of the neural network. The input layer, the intermediate layer, and the output layer may all include several neurons, and a directed connection with a variable weight may be used between the neurons. By means of repeated learning training of known information, the neural network achieves the purpose of establishing a model simulating the relationship between the input and output by a method of gradually adjusting and changing the connection weight of the neurons. The trained neural network may detect, by using the model simulating the relationship between the input and output, input information and give output information corresponding to the input information. For example, the neural network may include a convolutional layer, a pooling layer, and a fully connected layer. Features in the image may be extracted by using the neural network, and the states of the fingers in the image are determined according to the extracted features.

In the present embodiment, the states of the fingers included in the hand in the image may be quickly and accurately determined by using strong processing capability of the neural network.

In one possible implementation, the neural network includes multiple state branch networks. Step S11 includes: detecting the states of different fingers included in the hand in the image respectively via different state branch networks of the neural network.

In one possible implementation, five state branch networks may be set in the neural network, and each state branch network is configured to acquire the state of one finger from the image.

In one possible implementation, FIG. 6 shows a data processing flowchart of a neural network in a gesture recognition method according to embodiments of the present disclosure. In FIG. 6, the neural network may include a convolutional layer and a fully connected layer. The convolutional layer may include a first convolutional layer, a second convolutional layer, a third convolutional layer, and a fourth convolutional layer. The first convolutional layer may include one convolutional layer “conv1_1”, and the second to fourth convolutional layers may have two convolutional layers respectively, which, for example, may be “conv2_1” to “conv4_2”. The first convolutional layer, the second convolutional layer, the third convolutional layer, and the fourth convolutional layer may be configured to extract features in the image.

The fully connected layer may include a first fully connected layer “ip1_fingers”, a second fully connected layer “ip2_fingers”, and a third fully connected layer “ip3_fingers”. The first fully connected layer, the second fully connected layer, and the third fully connected layer may be configured to determine the states of the fingers and acquire the state vector of the fingers. “ip3_fingers” may be divided into five state branch networks, which are a first state branch network (loss_littlefinger), a second state branch network (loss_ringfinger), a third state branch network (loss_middlefinger), a fourth state branch network (loss_forefinger), and a fifth state branch network (loss_thumb) respectively. Each state branch network corresponds to one finger, and each state branch network may be individually trained.

In one possible implementation, the fully connected layer further includes a position branch network. Step S40 may include:

detecting position information of the fingers included in the hand in the image via the position branch network of the neural network.

In FIG. 6, the neural network further includes a position branch network, and the position branch network may include a fifth fully connected layer “ip1_points”, a sixth fully connected layer “ip2_points”, and a seventh fully connected layer “ip3_points”. The fifth fully connected layer, the sixth fully connected layer, and the seventh fully connected layer are configured to acquire the position information of the fingers.

In addition, in FIG. 6, the convolutional layer may further include an activation function (relu_conv), a pooling layer (pool), a loss function, and the like, and details are not described repeatedly.

In the present embodiment, the position information of the fingers may be determined from the image by using the position branch network, and the position information of the fingers is determined from the image by using the position branch network. The state information and position information of the fingers in the image may be quickly and accurately acquired according to the state branch network and the position branch network.

In one possible implementation, the neural network is obtained in advance by means of training by using a sample image with annotation information, the annotation information including first annotation information representing the states of the fingers, and/or second annotation information representing position information of the fingers or position information of the key points.

In one possible implementation, the annotation information of the sample image may include first annotation information representing the states of the fingers. In the training process of the neural network, the detected states of the fingers may be compared with the first annotation information to determine the loss of a gesture prediction result.

In one possible implementation, the annotation information of the sample image may include second annotation information representing position information of the fingers or position information of the key points. The positions of the fingers or the positions of the key points may be obtained according to the second annotation information, and the states of the fingers may be determined according to the positions of the fingers or the positions of the key points. In the training process of the neural network, the detected states of the fingers may be compared with the states of the fingers determined according to the second annotation information to determine the loss of a gesture prediction result.

In one possible implementation, the annotation information of the sample image may include first annotation information and second annotation information. In the training process of the neural network, the detected states of the fingers may be compared with the first annotation information, and the detected position information may be compared with the second annotation information to determine the loss of a gesture prediction result.

In one possible implementation, the first annotation information includes a state vector formed by a first identification value representing the states of the fingers; and the second annotation information includes a position vector formed by a second identification value identifying the position information of the fingers or the position information of the key points.

In one possible implementation, in the sample image, the second annotation information of the fingers in a non-outstretched state is not annotated. An invalid second identification value, for example, (−1, −1) may be set for the fingers in the non-outstretched state.

In one possible implementation, the identification value in the first annotation information may be determined according to the number of the states of the fingers. For example, the states of the fingers are a non-outstretched state or outstretched state, and then the first identification value in the first annotation information may include 0 (the non-outstretched state) or 1 (the outstretched state). The states of the fingers are a non-outstretched state, a half-outstretched state, a bent state, and an outstretched state, and then the first identification value may include 0 (the non-outstretched state), 1 (the half-outstretched state), 2 (the bent state), and 3 (the outstretched state). The first annotation information, for example, (0, 1, 1, 0, 0), of the hand may be obtained according to the first identification value of the fingers.

In one possible implementation, an image coordinate system may be established for the sample image, and the second identification value in the second annotation information is determined according to the established image coordinate system. The second annotation information, for example, (−1, −1, X₂, Y₂, X₃, Y₃, −1, −1, −1, −1), of the hand may be obtained according to the second identification value of the fingers.

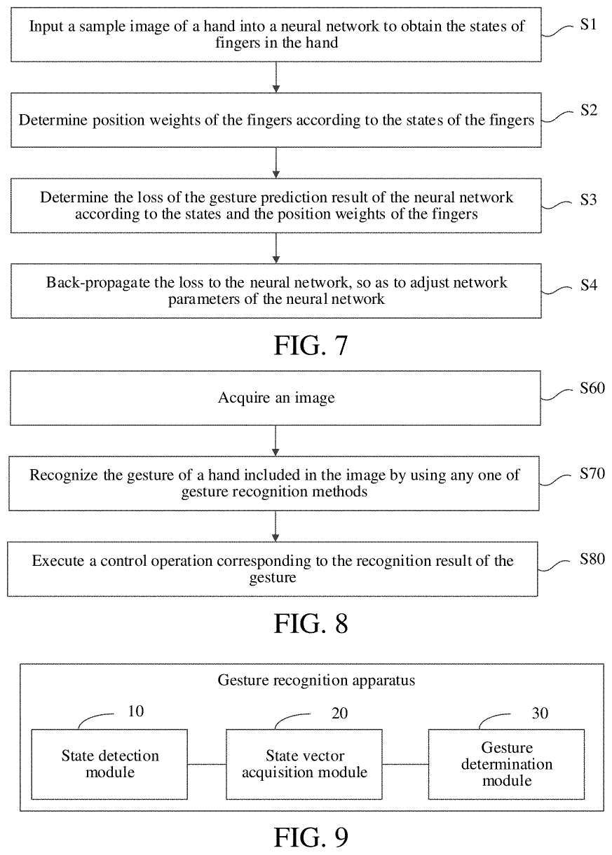

FIG. 7 shows a flowchart of a gesture recognition method according to embodiments of the present disclosure. As shown in FIG. 7, the training steps of the neural network include the following steps.

At step S1, a sample image of a hand is input into a neural network to obtain the states of fingers in the hand.

In one possible implementation, the inputting a sample image of a hand into a neural network to obtain the states of fingers in the hand includes: inputting a sample image of a hand into a neural network to obtain the states and position information of fingers in the hand.

In one possible implementation, the sample image of the hand may be an image annotated with the states and position information of the fingers. The sample image of the hand may be input into the neural network, features in the image are extracted via the neural network, and the states and position information of the fingers is determined according to the extracted features. In the subsequent step of gesture recognition, the gesture of the hand may be determined according to the determined states and position information of the fingers.

At step S2, position weights of the fingers are determined according to the states of the fingers.

In one possible implementation, different position weights may be set for different states of the fingers. For example, a relatively position weight may be set for fingers in an outstretched state, and a relatively low position weight may be set for fingers in a non-outstretched state.

In one possible implementation, the determining position weights of the fingers according to the states of the fingers includes: when the states of the fingers are the non-outstretched state, determining that the position weights of the fingers are zero weight.

In one possible implementation, when the states of the fingers are the outstretched state, it may be determined that the position weights of the fingers are non-zero weight; and when the states of the fingers are non-outstretched state, it may be determined that the position weights of the fingers are zero weight.

In one possible implementation, position information of key points of fingers in the outstretched state may be acquired, position information of the hand is obtained according to the position information of the key points of the fingers in the outstretched state, and then the gesture of the hand is determined according to the position information and state information of the hand. For example, in the image as shown in FIG. 2, the state vector of the hand is (0, 1, 1, 0, 0), and the position vector of the hand is (−1, −1, X₂, Y₂, X₃, Y₃, −1, −1, −1, −1). According to the state vector of the hand, the position weights may be set to be 1 for the forefinger and middle weight, the position weights are set to be 0 for the remaining three fingers, and it may be obtained that the position weight of the hand is (0, 0, 1, 1, 1, 1, 0, 0, 0, 0).

In one possible implementation, for the gesture of outstretching the forefinger and holding the other four fingers together, the state vector of the hand is (0, 1, 0, 0, 0), the position vector of the hand by taking fingertips as the key points is (−1, −1, X₂, Y₂, −1, −1, −1, −1, −1, −1), and the position weight is (0, 0, 1, 1, 0, 0, 0, 0, 0, 0). For the gesture of making a fist, the state vector of the hand is (0, 0, 0, 0, 0), the position vector of the hand by taking fingertips as the key points is (−1, −1, −1, −1, −1, −1, −1, −1, −1, −1), and the position weight is (0, 0, 0, 0, 0, 0, 0, 0, 0, 0). For the “OK” gesture of outstretching the middle finger, the ring finger, and the little finger, and joining the thumb and the forefinger, the state vector of the hand is (0, 0, 1, 1, 1), the position vector of the hand by taking fingertips as the key points is (−1, −1, −1, −1, X₃, Y₃, X₄, Y₄, X₅, Y₅), and the position weight is (0, 0, 0, 0, 1, 1, 1, 1, 1, 1).

At step S3, the loss of the gesture prediction result of the neural network is determined according to the states and position weights of the fingers.

In one possible implementation, determining the loss of the gesture prediction result of the neural network according to the states and position weights of the fingers includes: determining the loss of the gesture prediction result of the neural network according to the states, the position information, and the position weights of the fingers.

At step S4, the loss is back-propagated to the neural network, so as to adjust network parameters of the neural network.

In one possible implementation, in the back propagation process of the neural network, the values of the position vectors of the fingers in the non-outstretched state in the position vectors of the fingers would affect the calculation result of a loss function in the back propagation of the neural network. For example, back propagation is performed on the neural network only according to the states and position information of the fingers. In the image as shown in FIG. 2, the state vector of the hand is (0, 1, 1, 0, 0), and the position vector of the hand is (−1, −1, X₂, Y₂, X₃, Y₃, −1, −1, −1, −1). In the back propagation of the neural network, the position vectors of the thumb, ring finger, and little finger would approach −1, resulting in that a deviation occurs in the back propagation of the neural network, and the recognition result of the trained neural network is inaccurate. If the position weight (0, 0, 1, 1, 1, 1, 0, 0, 0, 0) of the hand is combined, in the back propagation of the neural network, the calculation of back propagation is performed on the weight vectors of the thumb, ring finger, and little finger, and the recognition result of the trained neural network is accurate.

In the present embodiment, by performing back propagation on the neural network according to the states, position information, and position weight of the fingers, the adverse effect caused to the back propagation by the values of position coordinates in the position information of the fingers, so that the trained neural network is more accurate.

FIG. 8 shows a flowchart of a gesture processing method according to embodiments of the present disclosure. The gesture processing method may be executed by an electronic device such as a terminal device or a server, where the terminal device may be a UE, a mobile device, a user terminal, a terminal, a cellular phone, a cordless phone, a PDA, a handheld device, a computing device, a vehicle-mounted device, a wearable device, or the like. In some possible implementations, the gesture processing method may be implemented by a processor by invoking computer-readable instructions stored in a memory.

As shown in FIG. 8, the method includes the following steps.

At step S60, an image is acquired.

At step S70, the gesture of a hand included in the image is recognized by using any one of the foregoing gesture recognition methods.

At step S80, a control operation corresponding to the recognition result of the gesture is executed.

In one possible implementation, a required image may be captured by a photography apparatus, or an image may be received directly in various types of receiving modes. The gesture of the hand included in the image may be recognized from the acquired image according to any one of the gesture recognition methods in the embodiments of the present disclosure. A corresponding control operation may be performed according to the gesture recognized from the image.

In one possible implementation, step S80 includes: acquiring, according to a predetermined mapping relationship between the gesture and a control instruction, a control instruction corresponding to the recognition result of the gesture; and controlling, according to the control instruction, an electronic device to execute a corresponding operation.

In one possible implementation, a mapping relationship between the gesture and a control instruction may be established according to requirements. For example, a “going forward” control instruction may be set for a gesture 1, and a “stopping” control instruction may be set for a gesture 2. After the gesture of the hand is determined from the image, a control instruction corresponding to the gesture is determined according to the gesture and the established mapping relationship.

In one possible implementation, an electronic device equipped on a robot, a mechanical device, a vehicle, or the like may be controlled according to the determined control instruction of the gesture, to implement automatic control over an apparatus such as a robot, a mechanical device, or a vehicle. For example, after an image of an hand of a controller may be captured by using a photography device equipped on a robot, the gesture in the captured images is recognized by using the gesture recognition method in the embodiments of the present disclosure, a control instruction is determined according to the gesture, and finally, automatic control over a robot is implemented. The present disclosure does not limit the type of the electronic device controlled by the control instruction.

In the present embodiments, the control instruction may be determined according to the gesture, and rich control instructions may be determined for the gesture in the image by establishing a mapping relationship between the gesture and the control instruction according to requirements. The electronic device may be controlled by means of the control instruction to achieve the purpose of controlling various apparatuses such as a vehicle.

In one possible implementation, step S80 includes: a special effect corresponding to the recognition result of the gesture is determined according to a predetermined mapping relationship between the gesture and a special effect; and the special effect is drawn on the mage by means of computer drawing.

In one possible implementation, a mapping relationship between the gesture and a special effect may be established. The special effect may be used for emphasizing the content of the gesture, or strengthening the expression capability of the gesture, and the like. For example, when it is recognized that the gesture is “victory”, the special effect of fireworks display may be made, and the like.

In one possible implementation, the special effect may be drawn by means of computer drawing, and the drawn special effect is displayed together with the content of the image. The special effect may include a two-dimensional sticker special effect, a two-dimensional image special effect, a three-dimensional special effect, an example special effect, a local image deformation special effect, and the like. The present disclosure does not limit the content, type, and implementation of the special effect.

In one possible implementation, the drawing the special effect on the mage by means of computer drawing includes:

The special effect is drawn by means of computer drawing based on the hand included in the image or key points of fingers of the hand

In one possible implementation, when the image is played back, additional information such as a text, a symbol, or an image is added to the image according to position information of the hand. The additional information may include one or any combination of the following information: a text, an image, a symbol, a letter, and a number. For example, at the fingertips of the fingers, a symbol such as “exclamation mark” or image information such as “lightning” is added for adding information needing to be expressed or emphasized by an editor to the image, thereby enriching the expression capability of the image.

In the present embodiment, according to the gesture, a special effect corresponding thereto may be determined, and the expression capability of the image is increased by adding the special effect to the image.

FIG. 9 shows a flowchart of a gesture recognition apparatus according to embodiments of the present disclosure. As shown in FIG. 9, the gesture recognition apparatus includes:

a state detection module 10 configured to detect the states of fingers included in a hand in an image;

a state vector acquisition module 20 configured to determine a state vector of the hand according to the states of the fingers; and

a gesture determination module 30 configured to determine the gesture of the hand according to the state vector of the hand.

In the present embodiment, the states of fingers included in a hand in an image are detected, a state vector of the hand is determined according to the states of the fingers, and the gesture of the hand is determined according to the determined state vector of the hand. In the embodiments of the present disclosure, the state vector is determined according to the states of the fingers, and the gesture is determined according to the state vector, thereby achieving high recognition efficiency and strong universality.

In one possible implementation, the states of the fingers represent the states of whether the fingers are outstretched with respect to the base of the palm of the hand and/or the extent of outstretching. When the gesture of the hand is making a fist, the fingers are in a non-outstretched state with respect to the base of the palm. When the fingers are in an outstretched state with respect to the base of the palm, the states of the fingers may also be further divided according to the positions of the fingers with respect to the palm or the degrees of bending of the fingers per se. For example, the states of the fingers may be divided into two states, i.e., a non-outstretched state and an outstretched state, may also be divided into three states, i.e., a non-outstretched state, a half-outstretched state, and an outstretched state, and may further be divided into multiple states such as an outstretched state, a non-outstretched state, a half-outstretched state, and a bent state.

In one possible implementation, the state vector acquisition module includes: a state value acquisition sub-module configured to determine state values of the fingers according to the states of the fingers, where the state values of fingers corresponding to different states are different; and a first state vector acquisition sub-module configured to determine a state vector of the hand according to the state values of the fingers.

In one possible implementation, corresponding state values may be determined for different states of the fingers, and correspondences between the states of the fingers and the state values are established. The state values of the fingers may be one or any combination of numbers, letters, or symbols. The state values of the fingers may be determined according to the acquired states of the fingers and the established correspondences, and then the state value of the hand is obtained by using the states of the fingers. The state vector of the hand may include various forms such as an array, a list, or a matrix.

In one possible implementation, the states of the fingers include one or more of the following: an outstretched state, a non-outstretched state, a half-outstretched state, or a bent state. According to the position relationship between the fingers and the palm and the degrees of bending of the fingers per se, in the process from fist making to outstretching of all the five fingers of the hand, the states of the fingers may sequentially be: a non-outstretched state, a half-outstretched state, a bent state, and an outstretched state. Different state levels may further be divided for different states of the fingers according to requirements. The present disclosure does not limit the classification mode, number, and use order of the states of the fingers.

In one possible implementation, the apparatus further includes: a position information acquisition module configured to detect position information of the fingers included in the hand in the image; and a position vector acquisition module configured to determine a state vector of the hand according to the position information of the fingers.

The gesture determination module includes: a first gesture determination sub-module configured to determine the gesture of the hand according to the state vector of the hand and the position vector of the hand.

In the present embodiment, the gesture of the hand may be determined according to the state vector and position vector of the hand. A more precise gesture may be obtained by combining the position vector and state vector of the hand.

In one possible implementation, the position information acquisition module includes: a key point detection sub-module configured to detect key points of the fingers included in the hand in the image to obtain position information of the key points of the fingers.

The position vector acquisition module includes: a first position vector acquisition sub-module configured to determine a position vector of the hand according to the position information of the key points of the fingers.

In the present embodiment, the position vector of the hand may be obtained according to the position information of the key points of the fingers of the hand. Thus, the determination process of the position vector of the hand is simpler.

In one possible implementation, the key point detection sub-module is configured to: detect key points of fingers, which are not in a non-outstretched state, included in the hand in the image, to obtain position information of the key points.

In the present embodiment, the position vector of the hand may be obtained according to the position information of the key points of the fingers which are not in the non-outstretched state. Thus, the determination process of the position vector of the hand is more efficient.

In one possible implementation, the key points include fingertips and/or phalangeal joints. The phalangeal joints may include metacarpophalangeal joints or interphalangeal joints. The position information of the fingers may be accurately represented by using positions of the fingertips and/or phalangeal joints of the fingers.

In one possible implementation, the state detection module includes: a first state detection sub-module configured to input the image into a neural network, and detect the states of the fingers included in the hand in the image via the neural network.

In the present embodiment, the states of the fingers included in the hand in the image may be quickly and accurately determined by using strong processing capability of the neural network.

In one possible implementation, the neural network includes multiple state branch networks. The first state detection sub-module is configured to detect the states of different fingers included in the hand in the image respectively via different state branch networks of the neural network.

In one possible implementation, five state branch networks may be set in the neural network, and each state branch network is configured to acquire the state of one finger from the image.

In one possible implementation, the neural network further includes a position branch network. The position information acquisition module includes: a first position information acquisition sub-module configured to detect position information of the fingers included in the hand in the image via the position branch network of the neural network.

In the present embodiment, the position information of the fingers may be determined from the image by using the position branch network, and the position information of the fingers is determined from the image by using the position branch network. The state information and position information of the fingers in the image may be quickly and accurately acquired according to the state branch network and the position branch network.

In one possible implementation, the neural network is obtained in advance by means of training by using a sample image with annotation information, the annotation information including first annotation information representing the states of the fingers, and/or second annotation information representing position information of the fingers or position information of the key points.

In one possible implementation, in the sample image, the second annotation information of the fingers in a non-outstretched state is not annotated. An invalid second identification value may be set for the fingers in the non-outstretched state.

In one possible implementation, the first annotation information includes a state vector formed by a first identification value representing the states of the fingers; and the second annotation information includes a position vector formed by a second identification value identifying the position information of the fingers or the position information of the key points.

In one possible implementation, the neural network includes a training module, and the training module includes: a state acquisition sub-module configured to input a sample image of a hand into a neural network to obtain the states of fingers in the hand; a position weight determination sub-module configured to determine position weights of the fingers according to the states of the fingers; a loss determination sub-module configured to determine the loss of the gesture prediction result of the neural network according to the states and position weights of the fingers; and a back-propagation sub-module configured to back-propagate the loss to the neural network, so as to adjust network parameters of the neural network.

In one possible implementation, the state acquisition sub-module is configured to: input a sample image of a hand into a neural network to obtain the states and position information of fingers in the hand; and the loss determination sub-module is configured to determine the loss of the gesture prediction result of the neural network according to the states, position information, and position weights of the fingers.

In the present embodiment, by performing back propagation on the neural network according to the states, position information, and position weight of the fingers, the adverse effect caused to the back propagation by the values of position coordinates in the position information of the fingers, so that the trained neural network is more accurate.

In one possible implementation, the position weight determination sub-module is configured to: when the states of the fingers are the non-outstretched state, determine that the position weights of the fingers are zero weight.

In one possible implementation, when the states of the fingers are the outstretched state, it may be determined that the position weights of the fingers are non-zero weight; and when the states of the fingers are non-outstretched state, it may be determined that the position weights of the fingers are zero weight.

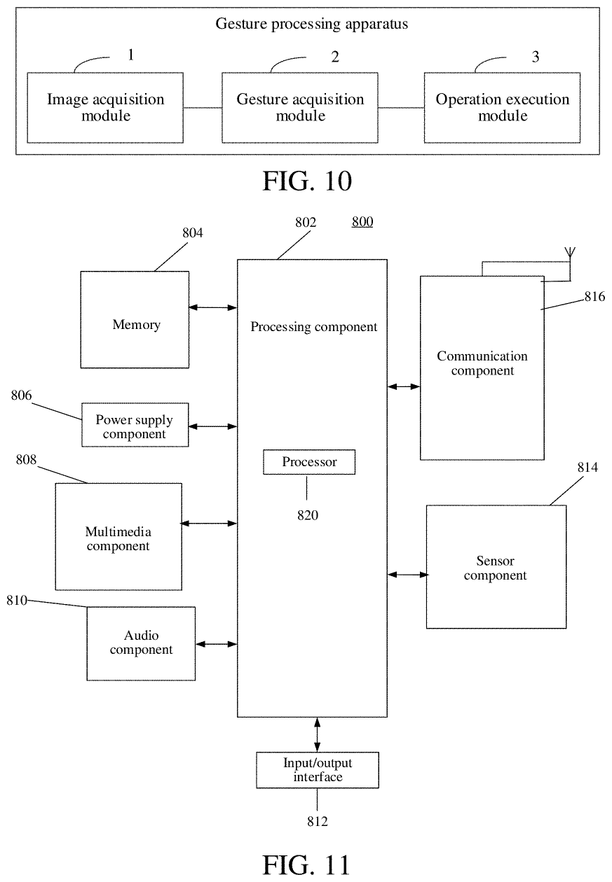

FIG. 10 shows a flowchart of a gesture processing apparatus according to embodiments of the present disclosure. As shown in FIG. 10, the apparatus includes:

an image acquisition module 1 configured to acquire an image;

a gesture acquisition module 2 configured to recognize the gesture of the hand included in the image by using any one of the foregoing gesture recognition apparatuses; and

an operation execution module 3, configured to execute a control operation corresponding to the recognition result of the gesture.

In one possible implementation, a required image may be captured by a photography apparatus, or an image may be received directly in various types of receiving modes. The gesture of the hand included in the image may be recognized from the acquired image according to any one of the gesture recognition methods in the embodiments of the present disclosure. A corresponding control operation may be performed according to the gesture recognized from the image.

In one possible implementation, the operation execution module includes: a control instruction acquisition sub-module configured to acquire, according to a predetermined mapping relationship between the gesture and a control instruction, a control instruction corresponding to the recognition result of the gesture; and an operation execution sub-module configured to control, according to the control instruction, an electronic device to execute a corresponding operation.

In the present embodiments, the control instruction may be determined according to the gesture, and rich control instructions may be determined for the gesture in the image by establishing a mapping relationship between the gesture and the control instruction according to requirements. The electronic device may be controlled by means of the control instruction to achieve the purpose of controlling various apparatuses such as a vehicle.

In one possible implementation, the operation execution module includes: a special effect determination sub-module configured to determine a special effect corresponding to the recognition result of the gesture according to a predetermined mapping relationship between the gesture and a special effect; and a special effect execution sub-module configured to draw the special effect on the mage by means of computer drawing.

In one possible implementation, the special effect execution sub-module is configured to draw the special effect by means of computer drawing based on the hand included in the image or key points of fingers of the hand.

In the present embodiment, according to the gesture, a special effect corresponding thereto may be determined, and the expression capability of the image is increased by adding the special effect to the image.

It may be understood that, the foregoing various method embodiments mentioned in the present disclosure may be combined with each other to form a combination embodiment without departing from the principle logic, and details are not described in the present disclosure repeatedly due to space limitation.

In addition, the present disclosure further provides apparatuses, an electronic device, a computer-readable storage medium, and a program, which may all be configured to implement any one of the gesture recognition methods or gesture processing methods provided in the present disclosure. For the corresponding technical solutions and descriptions, please refer to the corresponding content in the method section, and details are not described repeatedly.

The embodiments of the present disclosure further provide a computer-readable storage medium, having computer program instructions stored thereon, where when the computer program instructions are executed by a processor, any one of the foregoing method embodiments is implemented. The computer-readable storage medium may be a non-volatile computer-readable storage medium or a volatile computer-readable storage medium.

The embodiments of the present disclosure further provide an electronic device, including: a processor and a memory configured to store processor-executable instructions, where the processor implements any one of the method embodiments of the present disclosure by invoking the executable instructions. For the specific working process and setting mode, reference may be made to the foregoing corresponding method embodiment of the present disclosure, and details are not described herein repeatedly due to space limitation.

The embodiments of the present disclosure further provide a computer program, including a computer-readable code, where when the computer-readable code runs in an electronic device, a processor in the electronic device executes any one of the method embodiments of the present disclosure.

FIG. 11 is a block diagram of an electronic device 800 shown according to exemplary embodiments. For example, the electronic device 800 may be a terminal such as a mobile phone, a computer, a digital broadcast terminal, a message transceiving device, a game console, a tablet device, a medical device, exercise equipment, and a PDA.

With reference to FIG. 11, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 generally controls overall operation of the electronic device 800, such as operations associated with display, phone calls, data communications, camera operations, and recording operations. The processing component 802 may include one or more processors 820 to execute instructions to implement all or some of the steps of the methods above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, etc. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power component 806 provides power for various components of the electronic device 800. The power component 806 may include a power management system, one or more power supplies, and other components associated with power generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the electronic device 800 is in an operation mode, such as a calling mode, a recording mode, and a voice recognition mode. The received audio signal may be further stored in the memory 804 or transmitted by means of the communication component 816. In some embodiments, the audio component 810 further includes a speaker for outputting the audio signal.

The I/O interface 812 provides an interface between the processing component 802 and a peripheral interface module, which may be a keyboard, a click wheel, a button, etc. The button may include, but is not limited to, a home button, a volume button, a start button, and a lock button.

The sensor component 814 includes one or more sensors for providing state assessment in various aspects for the electronic device 800. For example, the sensor component 814 may detect an on/off state of the electronic device 800, and relative positioning of components, which are the display and keypad of the electronic device 800, for example, and the sensor component 814 may further detect a position change of the electronic device 800 or a component of the electronic device 800, the presence or absence of contact of the user with the electronic device 800, the orientation or acceleration/deceleration of the electronic device 800, and a temperature change of the electronic device 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the electronic device 800 and other devices. The electronic device 800 may access a wireless network based on a communication standard, such as WiFi, 2G, or 3G, or a combination thereof. In one exemplary embodiment, the communication component 816 receives a broadcast signal or broadcast-related information from an external broadcast management system by means of a broadcast channel. In one exemplary embodiment, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology, and other technologies.

In an exemplary embodiment, the electronic device 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the methods above.

In an exemplary embodiment, further provided is a non-volatile computer-readable storage medium, for example, a memory 804 including computer program instructions, which can executed by the processor 820 of the electronic device 800 to implement the methods above.

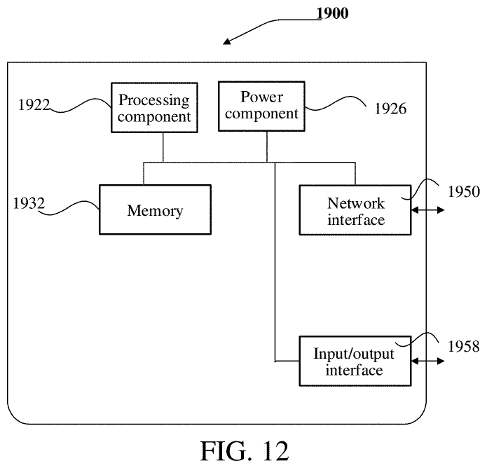

FIG. 12 is a block diagram of an electronic device 1900 shown according to exemplary embodiments. For example, the electronic device 1900 may be provided as a server. With reference to FIG. 12, the electronic device 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. In addition, the processing component 1922 is configured to execute instructions so as to execute the methods above.

The electronic device 1900 may further include a power component 1926 configured to execute power management of the electronic device 1900, a wired or wireless network interface 1950 configured to connect the electronic device 1900 to the network, and an I/O interface 1958. The electronic device 1900 may be operated based on an operating system stored in the memory 1932, such as Windows Server™, Mac OS X™, Unix™, Linux™, FreeBSD™ or the like.

In an exemplary embodiment, further provided is a non-volatile computer-readable storage medium, for example, a memory 1932 including computer program instructions, which can executed by the processing component 1922 of the electronic device 1900 to implement the methods above.

The present disclosure may be a system, a method, and/or a computer program product. The computer program product may include a computer-readable storage medium having computer-readable program instructions thereon for causing a processor to carry out various aspects of the present disclosure.

The computer-readable storage medium may be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. More specific examples (a non-exhaustive list) of the computer-readable storage medium include: a portable computer diskette, a hard disk, a Random Access Memory (RAM), an ROM, an EPROM (or a flash memory), an SRAM, a portable Compact Disk Read-Only Memory (CD-ROM), a Digital Versatile Disc (DVD), a memory stick, a floppy disk, a mechanically encoded device such as punch-cards or raised structure in a groove having instructions stored thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a Local Area Network (LAN), a Wide Area Network (WAN) and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may be executed entirely on the user's computer, partly on the user's computer, as a stand-alone software package, partly on the user's computer and partly on a remote computer or entirely on the remote computer or server. In a scenario involving a remote computer, the remote computer may be connected to the user's computer through any type of network, including an LAN or a WAN, or the connection may be made to an external computer (for example, through the Internet using an Internet service provider). In some embodiments, electronic circuitry including, for example, programmable logic circuitry, FPGAs, or Programmable Logic Arrays (PLAs) may execute the computer-readable program instructions by utilizing state information of the computer-readable program instructions to personalize the electronic circuitry, in order to implement the various aspects of the present disclosure.

The various aspects of the present disclosure are described herein with reference to flowcharts and/or block diagrams of methods, apparatuses (systems), and computer program products according to the embodiments of the present disclosure. It should be understood that, each block of the flowcharts and/or block diagrams, and combinations of the blocks in the flowcharts and/or block diagrams can be implemented by computer-readable program instructions.

These computer-readable program instructions may be provided to a processor of a general-purpose computer, special-purpose computer, or other programmable data processing apparatus to produce a machine, such that the instructions, which are executed via the processor of the computer or other programmable data processing apparatus, create means for implement the functions/acts specified in one or more blocks of the flowcharts and/or block diagrams. These computer-readable program instructions may also be stored in a computer-readable storage medium that can cause a computer, a programmable data processing apparatus, and/or other devices to function in a particular manner, such that the computer-readable medium having instructions stored therein includes an article of manufacture including instructions which implement the aspects of the functions/acts specified in one or more blocks of the flowcharts and/or block diagrams.

The computer-readable program instructions may also be loaded onto a computer, other programmable data processing apparatus, or other device to cause a series of operational steps to be performed on the computer, other programmable apparatus or other device to produce a computer implemented process, such that the instructions which can be executed on the computer, other programmable apparatus or other device implement the functions/acts specified in one or more blocks of the flowcharts and/or block diagrams.

The flowcharts and block diagrams in the accompanying drawings illustrate the architecture, functionality, and operations of possible implementations of systems, methods, and computer program products according to multiple embodiments of the present disclosure. In this regard, each block in the flowcharts or block diagrams may represent a module, program segment, or a portion of the instructions, which includes one or more executable instructions for implementing the specified logical function(s). In some alternative implementations, the functions noted in the block may also occur out of the order noted in the accompanying drawings. For example, two blocks shown in succession may, in fact, be executed substantially concurrently, or the blocks may sometimes be executed in the reverse order, depending upon the functionality involved. It should also be noted that, each block of the block diagrams and/or flowcharts, and combinations of blocks in the block diagrams and/or flowcharts, may be implemented by special purpose hardware-based systems that perform the specified functions or acts or carried out by combinations of special purpose hardware and computer instructions.

Different embodiments of the present application may be combined with each other without departing from the logic. The descriptions of different embodiments all have their own focuses, and for portions that are not focused, reference may be made to the descriptions in other embodiments.

The descriptions of the embodiments of the present disclosure have been presented for purposes of illustration, but are not intended to be exhaustive or limited to the embodiments disclosed. Many modifications and variations will be apparent to a person of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

What is claimed is:

1. A gesture recognition method, comprising:
detecting states of fingers comprised in a hand in an image;
determining a state vector of the hand according to the states of the fingers; and
determining the gesture of the hand according to the state vector of the hand.

2. The method according to claim 1, wherein the states of the fingers represent the states of whether the fingers are outstretched with respect to the base of a palm of the hand and/or an extent of outstretching.

3. The method according to claim 1, wherein determining the state vector of the hand according to the states of the fingers comprises:
determining state values of the fingers according to the states of the fingers, wherein the state values of fingers corresponding to different states are different; and
determining the state vector of the hand according to the state values of the fingers.

4. The method according to claim 1, wherein the states of the fingers comprise one or more of the following: an outstretched state, a non-outstretched state, a half-outstretched state, or a bent state.

5. The method according to claim 1, further comprising:
detecting position information of the fingers comprised in the hand in the image; and
determining a position vector of the hand according to the position information of the fingers,
wherein determining the gesture of the hand according to the state vector of the hand comprises:
determining the gesture of the hand according to the state vector of the hand and the position vector of the hand.

6. The method according to claim 5, wherein detecting the position information of the fingers comprised in the hand in the image comprises:
detecting key points of the fingers comprised in the hand in the image to obtain position information of the key points of the fingers; and
the determining the position vector of the hand according to the position information of the fingers comprises:
determining the position vector of the hand according to the position information of the key points of the fingers.

7. The method according to claim 6, wherein detecting the key points of the fingers comprised in the hand in the image to obtain the position information of the key points of the fingers comprises:
detecting the key points of fingers, which are not in a non-outstretched state, comprised in the hand in the image, to obtain the position information of the key points.

8. The method according to claim 7, wherein the key points comprise fingertips and/or phalangeal joints.

9. The method according to claim 1, wherein detecting the states of fingers comprised in the hand in the image comprises:
inputting the image into a neural network, and detecting the states of the fingers comprised in the hand in the image via the neural network.

10. The method according to claim 9, wherein the neural network comprises multiple state branch networks, and the detecting the states of the fingers comprised in the hand in the image via the neural network comprises:
detecting the states of different fingers comprised in the hand in the image respectively via different state branch networks of the neural network.

11. The method according to claim 9, wherein the neural network further comprises a position branch network, the method further comprises detecting a position information of the fingers comprised in the hand in the image, and the detecting the position information of the fingers comprised in the hand in the image comprises:
detecting the position information of the fingers comprised in the hand in the image via the position branch network of the neural network.

12. The method according to claim 9, wherein the neural network is obtained in advance by means of training by using a sample image with annotation information, the annotation information comprising first annotation information representing the states of the fingers, and/or second annotation information representing the position information of the fingers or the position information of the key points.

13. The method according to claim 12, wherein in the sample image, the second annotation information of the fingers in the non-outstretched state is not annotated.

14. The method according to claim 12, wherein the first annotation information comprises the state vector composed of a first identification value representing the state of each finger; and
the second annotation information comprises the position vector composed by a second identification value identifying the position information of each finger or the position information of the key points.

15. The method according to claim 9, wherein training steps of the neural network comprises:
inputting the sample image of a hand into the neural network to obtain the states of fingers in the hand;
determining position weights of the fingers according to the states of the fingers;
determining the loss of the gesture prediction result of the neural network according to the states and the position weights of the fingers; and
back-propagating the loss to the neural network, so as to adjust network parameters of the neural network.

16. The method according to claim 15, wherein inputting the sample image of the hand into the neural network to obtain the states of the fingers in the hand comprises:
inputting the sample image of the hand into the neural network to obtain the states and the position information of fingers in the hand; and
the determining the loss of the gesture prediction result of the neural network according to the states and the position weights of the fingers comprises:
determining the loss of the gesture prediction result of the neural network according to the states, the position information, and the position weights of the fingers.

17. The method according to claim 15, wherein determining the position weights of the fingers according to the states of the fingers comprises:
when the states of the fingers are the non-outstretched state, determining that the position weights of the fingers are zero weight.

18. The method according to claim 1, further comprising:
acquiring, according to a predetermined mapping relationship between the gesture and a control instruction, a control instruction corresponding to a determined result of the gesture, and controlling, according to the control instruction, an electronic device to execute a corresponding operation;
or,
determining a special effect corresponding to the determined result of the gesture according to the predetermined mapping relationship between the gesture and a special effect, and drawing the special effect on the mage by means of computer drawing.

19. An electronic device, comprising:
a processor; and
a memory configured to store processor-executable instructions,
wherein the processor is configured to invoke the instructions stored in the memory, so as to:
detect states of fingers comprised in a hand in an image;
determine a state vector of the hand according to the states of the fingers; and
determine the gesture of the hand according to the state vector of the hand.

20. A non-transitory computer-readable storage medium, having computer program instructions stored thereon, wherein when the computer program instructions are executed by a processor, the processor is caused to perform the operations of:
detecting states of fingers comprised in a hand in an image;
determining a state vector of the hand according to the states of the fingers; and
determining the gesture of the hand according to the state vector of the hand.
